(19) United States
(12) Patent Application Publication
(10) Pub. No.: US 2026/0172355 A1
(43) Pub. Date: Jun. 18, 2026

(54) NETWORK DEVICE AND METHOD WITH ANTICIPATORY PATH CONTROL

(71) Applicant: Samsung Electronics Co., Ltd., Suwon-si (KR)

(72) Inventors: Wonyoung LEE, Suwon-si (KR); Yong In LEE, Suwon-si (KR); Wonseok LEE, Suwon-si (KR); Seokbin HONG, Suwon-si (KR)

(73) Assignee: Samsung Electronics Co., Ltd., Suwon-si (KR)

(21) Appl. No.: 19/230,505

(22) Filed: Jun. 6, 2025

(30) Foreign Application Priority Data
Dec. 13, 2024 (KR) 10-2024-0186175

(51) Int. Cl. H04L 47/122; H04L 47/76

(52) U.S. Cl. CPC H04L 47/122; H04L 47/76

(57) ABSTRACT

A network device is disclosed. The network device includes a plurality of ports, a controller configured to distinguish whether a packet obtained from a first port among the plurality of ports is a request packet or a response packet, and a payload size accumulator (PSA) configured to add or subtract a payload size based on a result of the distinguishment, in which the controller is configured to, based on a value of the PSA, control a data transmission path of the network device or a state of a resource allocated to the network device.

### CROSS-REFERENCE TO RELATED APPLICATIONS

This application claims the benefit under 35 USC § 119(a) of Korean Patent Application No. 10-2024-0186175, filed on December 13, 2024, in the Korean Intellectual Property Office, the entire disclosure of which is incorporated herein by reference for all purposes.

### BACKGROUND

### 1. Field

The following description relates to a network device and an operating method thereof, and more particularly, to a method and device for determining a bypass path through a traffic prediction in a network topology, which has multiple paths, and optimizing resource utilization.

### Description of Related Art

A network device may manage the transmission and reception of data packets and may adjust data flow in a network through communication with various devices. Recently, the amount of data traffic has been rapidly increasing in a network environment, and as a result, the possibility of traffic congestion is increasing. Such congestion may cause a delay in data transmission or lead to inefficient utilization of a network resource.

Existing network devices may mainly operate by setting a data path or managing a resource based on a current state. This method may be difficult to adapt to a dynamic change in traffic or a transmission situation of large-scale data and may not be able to perform decision-making based on a prediction. In particular, a prediction of data flow may become more complicated in an environment where a request packet and a response packet coexist in a network.

Therefore, a new method in which a network device predicts the possibility of the occurrence of traffic congestion in advance and efficiently uses a resource may be required. This technology may contribute to more flexibly managing a data transmission path or increasing the utilization of a network resource. In addition, this technology may become a technological foundation that may support stable data communication even in a large-scale network environment.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an operating method, of a network device including ports, includes: determining whether a packet obtained from a first port among the ports is a request packet or a response packet; updating a value of a payload size accumulator (PSA) based on a result of the determining; and based on the value of the PSA, controlling a data transmission path of the network device or a state of a resource allocated to the network device.

The obtained packet may be a request packet, and the updating of the value of the PSA may include obtaining a payload size of a response packet to be received as a response to the request packet, the payload size obtained from a header of the request packet based on the obtained packet being a request packet.

The obtained packet may be a request packet, and the updating of the value of the PSA may include increasing the value of the PSA based on a payload size of a response packet to be received as a response to the request packet, the payload size obtained based on the obtained packet being a request packet.

The obtained packet may be a response packet, and the updating of the value of the PSA may include decreasing the value of the PSA based on a payload size of the response packet, the payload size obtained based on the obtained packet being a response packet.

The obtained packet may be a request packet, and the controlling the data transmission path based on the value of the PSA may include: determining that the value of the PSA satisfies a preset first condition, and based thereon limiting transmission of the request packet to the data transmission path through the first port.

The method may further include: determining that traffic congestion occurs in the data transmission path through the first port in response to the value of the PSA satisfying a preset first condition, and based thereon, securing an additional path by changing, among the ports, a power state of a port.

Based on the value of the PSA satisfying a preset second condition, the resource allocated to the network device may be freed or reclaimed.

The method may further include: obtaining the state of the resource allocated to the network device; and the controlling the data transmission path or the state of the resource may also be based on the obtained state of the resource allocated to the network device.

The obtained packet may be a response packet, which is received as a response to a request packet transmitted through the data transmission path through the first port, and the obtained response packet may be received by the first port through the same data transmission path.

The network device may include a computing device or a switch.

A non-transitory computer-readable storage medium stores instructions that, when executed by a processor, cause the processor to perform any of the methods.

In another general aspect, a network device includes: ports; a controller configured to determine whether a packet obtained from a first port among the ports is a request packet or a response packet; a payload size accumulator (PSA) including a register or queue, configured to add-to or subtract-from, a value maintained in the register or queue, a payload size based on a result of the determining; and wherein the controller is further configured to: based on the value, control a data transmission path of the network device or a state of a resource allocated to the network device.

The obtained packet may be a request packet, the payload size may be a payload size of a response packet to be received as a response to the request packet, and the payload size of the response packet may be obtained from a header of the request packet.

The obtained packet may be a request packet, and based thereon the PSA may add, to the value, a payload size of a response packet that is to be received as a response to the request packet.

The obtained packet may be a response packet, and the PSA may be configured to subtract a payload size of the obtained response packet based on the obtained packet being a response packet.

The controller may be configured to: select the first port based on the value of the PSA satisfying a preset first condition, and, based thereon, limit transmission of the obtained packet to the data transmission path through the first port based.

The controller may be configured to: select the first port based on the value of the PSA satisfying a preset first condition, and, based thereon, secure an additional path by changing, among the ports, a power state of a port of which the power state corresponds to satisfaction of the preset first condition.

The controller may be configured to: based on the value of the PSA satisfying a preset second condition, free or reclaim the resource allocated to the network device.

The controller may be configured to: obtain the state of the resource allocated to the network device; and control the data transmission path or the state of the resource based on the value of the PSA and based on the state of the resource allocated to the network device.

The obtained packet may be a response packet which is received as a response to a corresponding request packet transmitted through the data transmission path through the first port, and the response packet may be received by the first port through the same data transmission path.

Other features and aspects will be apparent from the following detailed description, the drawings, and the claims.

### BRIEF DESCRIPTION OF THE DRAWINGS

FIG. 1 illustrates an example of a multi-path network topology system, according to one or more embodiments.

FIG. 2 illustrates an example of a structure of a high-performance computing (HPC) cluster of a multi-path network topology system, according to one or more embodiments.

FIG. 3 illustrates an example of a data transmission relationship between a network device and a network, according to one or more embodiments.

FIGS. 4A and 4B illustrate examples of an operation in which a request packet and a response packet are transmitted in a network environment, according to one or more embodiments.

FIG. 5 illustrates an example of components and an operating method of a network device, according to one or more embodiments.

FIG. 6 illustrates an example of components and an operating method of a switch, according to one or more embodiments.

FIG. 7 illustrates an example of components and an operating method of a computing device, according to one or more embodiments.

FIG. 8 illustrates an example of components and an operating method of a controller, according to one or more embodiments.

FIGS. 9A and 9B illustrate examples of a structure in which an independent payload size accumulator (PSA) exists in each of a transmission channel and a reception channel of a port, according to one or more embodiments.

FIG. 10 illustrates an example of a hardware configuration of a PSA and illustrates an operation of addition and subtraction of a value of the PSA based on a 4-bit structure, according to one or more embodiments.

FIG. 11 illustrates an example of an operating method of a network device, according to one or more embodiments.

FIG. 12 illustrates an example of an operating method of a network device, according to one or more embodiments.

FIG. 13 illustrates an example of a process of determining routing in a switch, according to one or more embodiments.

FIG. 14 illustrates an example of a process in which a network device dynamically changes a power state to achieve resource utilization and power optimization, according to one or more embodiments.

FIG. 15 illustrates an example of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles "a," "an," and "the" are intended to include the plural forms as well, unless the context clearly indicates otherwise. As used herein, the term "and/or" includes any one and any combination of any two or more of the associated listed items. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being "connected to," "coupled to," or "joined to" another component or element, it may be directly "connected to," "coupled to," or "joined to" the other component or element, or there may reasonably be one or more other components or elements intervening therebetween. When a component or element is described as being "directly connected to," "directly coupled to," or "directly joined to" another component or element, there can be no other elements intervening therebetween. Likewise, expressions, for example, "between" and "immediately between" and "adjacent to" and "immediately adjacent to" may also be construed as described in the foregoing.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term "may" herein with respect to an example or embodiment, e.g., as to what an example or embodiment may include or implement, means that at least one example or embodiment exists where such a feature is included or implemented, while all examples are not limited thereto.

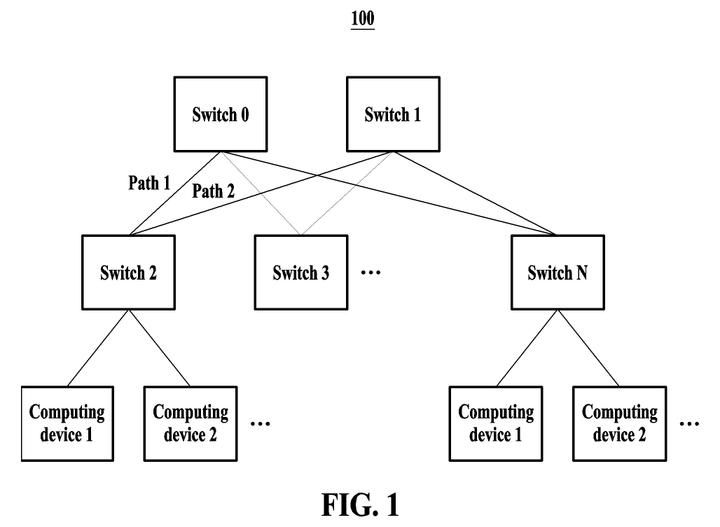

FIG. 1 illustrates an example of a multi-path network topology system 100, according to one or more embodiments.

Referring to FIG. 1, the multi-path network topology system 100 may include switches and computing devices, and multiple data transmission paths may exist through the switches. This structure may provide flexibility in data transmission in a large-scale network environment and provide a foundation for alleviating traffic congestion or increasing the utilization of a network resource.

The multi-path network topology system 100 may be a hierarchy of interconnected layers. A top layer may include switch 0 and switch 1, each of which may be connected to all of the switches in the next layer, e.g., switch 2, switch 3, … switch N. That is, each switch in each layer may be connected to all of the switches in the layer above (or below) it. Each switch in the lowest layer may be connected to two corresponding computing devices. The switch 2 may be connected to its own computing device 1 and computing device 2, switch 3 may be connected to its own computing device 1 and computing device 2, and so forth up to the switch N. This network structure may provide a multi-path environment in which multiple data transmission paths (path 1, path 2, etc.) exist. However, the structure illustrated in FIG. 1 is an example, and the present disclosure may be implemented in the same or similar manner in various network topology environments. For example, the number of network devices or the number of paths may change depending on the implementation environment, and the present disclosure may be flexibly applied to such changes.

The switches are network devices to transmit a data packet along a certain path and may transmit and receive a request packet and a response packet. For example, the switch 0 and the switch 1 may manage upper-level traffic and transmit data to a lower level or transmit data to other switches or computing devices by receiving the data from the lower level. Multiple paths may be provided between the switches, for example, when data is desired to be transmitted from the switch 0 to the switch N, either the path 1 or the path 2 may be selected. Such a structure of the paths may provide flexibility to dynamically select or change a path depending on the traffic state. A path may be a device-to-device link or may include one or more switches.

The computing devices are capable of performing data processing and storage and may be, for example, servers, workstations, or other network devices. The computing devices may transmit a data request or receive response data through a network. For example, a data request packet may be transmitted from the computing device 1 to the switch 0 through the switch 2 and a response packet for a corresponding request may be received back.

The multi-path network topology system 100 may increase the stability of data transmission by dynamically changing a path to alleviate traffic congestion or activating an inactivated path. In addition, when the possibility of traffic congestion is predicted in a certain switch or port, the network performance may be optimized by transmitting a request packet through a bypass path. This path-adjusting operation may be possible through a traffic prediction and resource management mechanism described herein.

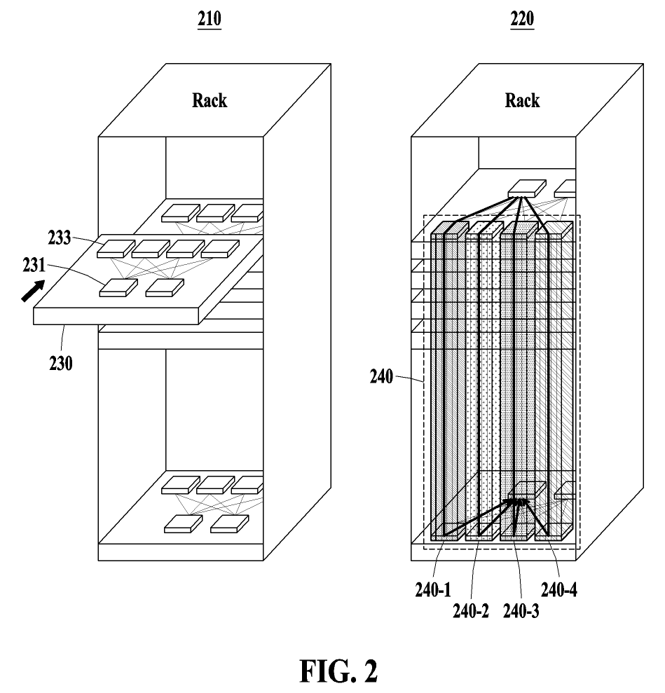

FIG. 2 illustrates an example of a structure of a high-performance computing (HPC) cluster of a multi-path network topology system, according to one or more embodiments.

Diagram 210 of FIG. 2 illustrates the front of a rack of the HPC cluster; the HPC cluster may include multiple racks (nodes), and each rack may include multiple computing boards.

A computing board 230 may include computing devices 231 and switches 233. The computing devices 231 perform data operations and storage and each may include a memory and a processor. The memory stores data and may be a high-speed memory such as high-bandwidth memory (HBM) or a double data rate (DDR) memory. The processor is a device that performs operations and may include an X processing unit (xPU), such as a central processing unit (CPU), a graphics processing unit (GPU), a neural processing unit (NPU), and a tensor processing unit (TPU), and/or a programmable device such as a field programmable gate array (FPGA). The switches 233 are responsible for data transmission between the computing devices 231, which may control data flow and perform traffic distribution.

Diagram 220 of FIG. 2 illustrates the rear of the rack of the HPC cluster, a switch fabric 240 may form a path for data transmission and may be divided into planes 240-1, 240-2, 240-3, and 240-4. The planes 240-1, 240-2, 240-3, and 240-4 are layers that divide the switch fabric 240 and may play an important role in determining a data transmission path. In order for the computing devices 231 to transmit data to devices located in other computing boards, the computing devices 231 may first select the switches 233 included in the board of the computing devices 231 and determine a plane (e.g., the plane 240-1) to be used.

After a plane is determined, the data may be transmitted by setting a path between switches in the corresponding plane. For example, when the computing devices 231 determine to transmit the data through the plane 240-2, the data may be transmitted along a path between switches included in the plane 240-2. In this process, using a point-to-point circuit type of connection, a plane may not be changed in the middle of data transmission, and all pieces of data transmission may be performed through the selected plane.

However, the multi-path network topology system 100 may be applied to a universal network environment in addition to a special-purpose network environment such as the HPC cluster. For example, the multi-path network topology system 100 may be used in a data center, a cloud infrastructure, a distributed network, or a general Internet-based communication environment. Since the multi-path network topology system 100 is designed based on a multi-path network environment that may simultaneously use multiple paths through a communication fabric, the number of paths may not be limited and the multi-path network topology system 100 may adapt to various pieces of network equipment and structures.

For example, the multi-path network topology system 100 may distribute a traffic load using a multi-path when transmitting data between a core switch and an edge switch in a data center and may be applied to optimize data replication and distributed storage in a cloud environment.

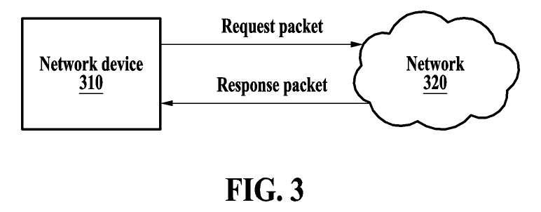

FIG. 3 illustrates an example of a data transmission relationship between a network device and a network, according to one or more embodiments.

The multi-path network topology system 100 may be designed based on a request-and-response communication method that requests and responds for and to data. In a communication environment, when a terminal that desires to receive data transmits a request packet, communication may be performed by returning a response packet including the requested data by the terminal that receives the request packet. For example, in a peripheral component interconnect express (PCIe) environment, a data request and response may follow such a request-response communication method.

A network device 310 may generate a request packet and transmit the request packet to a network 320. The request packet may include a command to request certain data or perform a task. The network 320 may relay the request packet, generate a response packet including the processed result, and transmit the response packet back to the network device 310. The network device 310 may be a switch or a computing device (but generally, not as both at the same time). When the network device 310 operates as a switch, the network device 310 may set a path of a request packet and a response packet and relay the same thereon. Alternatively, when the network device 310 operates as a computing device, the network device 310 may perform the task of processing a request packet or generating a response packet.

As described in detail below, the network device 310 may manage a data transmission path based on the flow therethrough of the request packet and the response packet. Before the request packet is transmitted to the network 320, the network device 310 may obtain an expected size of the response packet based on size information of data included in a header of the request packet. Through this, the network device 310 may dynamically adjust a traffic path or alleviate a congestion state. For example, when traffic congestion is expected to occur, the network device 310 may change the path of the request packet or set a bypass path.

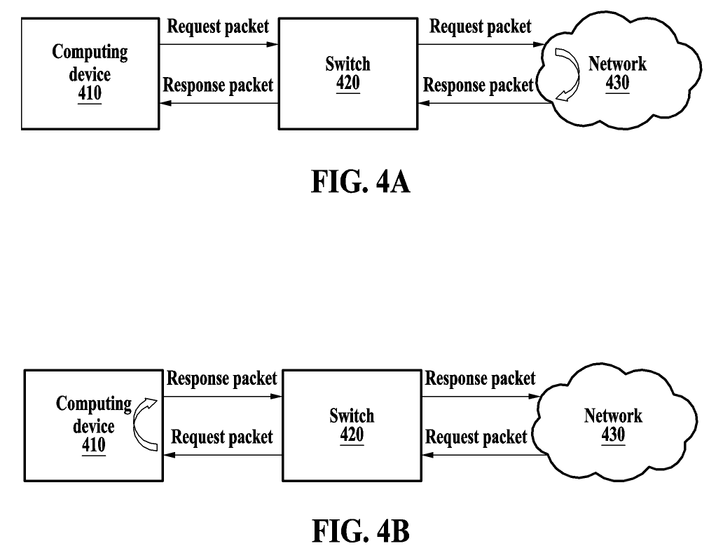

FIGS. 4A and 4B illustrate examples of an operation in which a request packet and a response packet are transmitted in a network environment, according to one or more embodiments.

Referring to FIG. 4A, a computing device 410 may generate a request packet to bring data from a remote terminal in a network 430. In this process, the request packet may first be transmitted to a switch 420 and from there be transmitted to the network 430. The network 430 may transmit the request packet to a destination terminal (not shown), and the destination terminal that receives the request packet may return, to the switch 420, back through the network 430, the requested data in a response packet. The switch 420 may complete data transmission by receiving the response packet and then transmitting the response packet to the requesting computing device 410. This process is a basic operation in which a request and a response are performed in data communication between the computing device 410 and the network 430.

In FIG. 4A, the response packet for the request packet may take a relatively long to be returned after being transmitted through the network 430. This may be because the response packet is generated from a terminal in a remote network. Accordingly, in the environment of FIG. 4A, a more global and large-scale traffic prediction by the switch 420 may be possible based on the traffic of a packet that is received by the switch 420. Since a header of the request packet may include information related to the payload size of the response packet, the switch 420 may analyze the request packet and predict the size of the response packet that is to arrive later. The predicted size of the response packet may be used by the switch 420 to predict and respond to traffic congestion that will occur later in the network 430.

FIG. 4B illustrates a case in which the computing device 410 operates as a terminal that generates a response packet in the network 430. Referring to FIG. 4B, when a remote terminal (not shown) transmits a request packet to the switch 420 through the network 430, the switch 420 may transmit the request packet to the computing device 410. After the request packet is processed or serviced, the computing device 410 may transmit the corresponding generated response packet back to the network 430 through the switch 420. In this case, the time until the response packet is transmitted to the network 430 through the switch 420 may be relatively short. This may be because the computing device 410 that generates the response packet is located close to the switch 420. Accordingly, in the environment of FIG. 4B, the switch 420 may perform a more local and short-term traffic prediction (relative to the prediction described with reference to FIG. 4A).

The environments of FIGS. 4A and 4B describe a mechanism in which the switch 420 may predict and handle future traffic based on the traffic flow of the request packet and the response packet. The header of the request packet may include information related to the data size of the response packet that arrives later. The switch 420 may examine the request packet and predict the size of the response packet to be received later, and through this, the network state may be analyzed in advance. This method may be used for the switch 420 to predict traffic congestion and set an appropriate path in advance or dynamically allocate a resource, in other words, configure resources in anticipation of the upcoming predicted traffic.

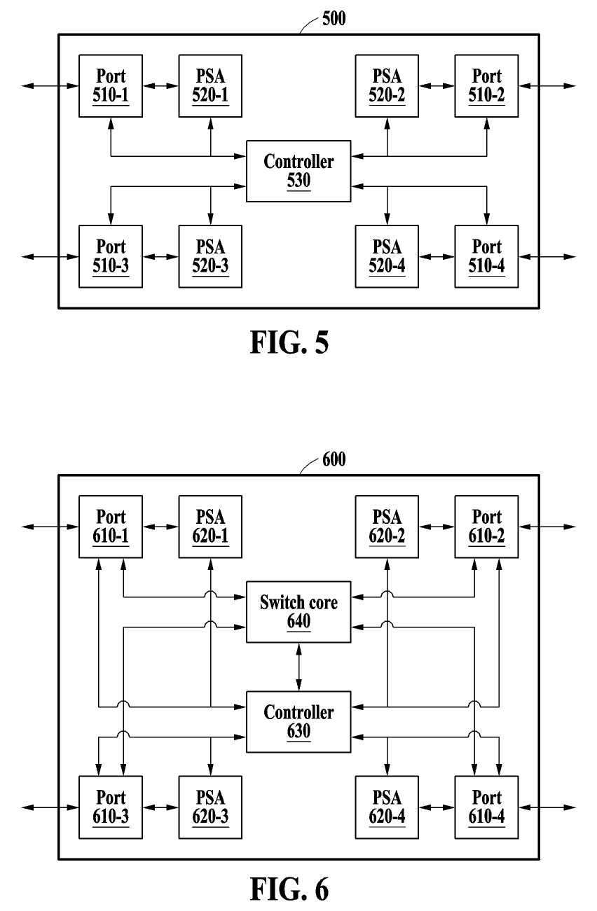

FIG. 5 illustrates an example of components and an operating method of a network device, according to one or more embodiments.

Referring to FIG. 5, a network device 500 may include ports 510-1, 510-2, 510-3, and 510-4, payload size accumulators (PSAs) 520-1, 520-2, 520-3, and 520-4, and a controller 530. Each port may correspond to a connection/link between the network device 500 and another device (e.g., a switch or a computing device). Not all of the illustrated components are essential; more or fewer components may be provided. Furthermore, the number of ports, the number of PSAs, and the coupling relationship between each component are only examples, and the network device 500 is not limited thereto. The network device 500 may include a greater number of ports and PSAs and may be implemented in a more simplified configuration if needed.

Referring to FIG. 5, each of the ports 510-1, 510-2, 510-3, and 510-4 may serve as an interface for transmitting and receiving data to and from the outside of the network device 500. Each of the ports 510-1, 510-2, 510-3, and 510-4 may analyze (or have analyzed) a packet obtained thereby from the outside of the network device 500 to distinguish whether the packet is a request packet or a response packet. This distinguishment may be performed in association with the controller 530, and through this, values of the PSAs 520-1, 520-2, 520-3, and 520-4 respectively associated with the ports 510-1, 510-2, 510-3, and 510-4 may be updated according to the type of each packet. For example, when a port determines that a packet received thereby is a request packet, the port may cause a PSA specifically associated with the port to analyze a header of the request packet (as described shortly). Absent some intervention, request packets and their corresponding response packets may use the same data transmission path and pass through the same port on that path. For example, a response packet received as a response to a request packet transmitted through a data transmission path including the port 510-1 may be received by the port 510-1 through the same data transmission path.

The PSAs 520-1, 520-2, 520-3, and 520-4 may store respective sums of the expected sizes of response packets that have not arrived yet (or that have not even been generated yet) at the respective ports 510-1, 510-2, 510-3, and 510-4. Each of the PSAs 520-1, 520-2, 520-3, and 520-4 may analyze a header of a request packet received thereby, calculate the expected size(s) of corresponding response packet(s), and then update the corresponding sums thereof by adding (or in some cases subtracting from) the calculated result thereto. For example, when the header of a request packet received by port 510-1 specifies the expected data size(s) of the response packets, the PSA 520-1 may determine the same and may add the corresponding size to a current value (e.g., a running sum) of PSA 520-1. When the actual response packet(s) arrive at port 510-1, the sizes of the response packet(s) may be subtracted from PSA 520-1's sum/total so an accurate predicted/expected traffic state may be reflected by the sum of PSA 520-1 (the same applies to the other ports and their respective PSAs). In this way, the PSAs 520-1, 520-2, 520-3, and 520-4 may track the traffic load of packets being processed in real time in certain respective ports.

Regarding the payload size, the payload size may be reflected in the PSA as a cumulative total amount, and this value may be decremented as actual responses are received. This structure can be interpreted as taking into account multiple response packets. Therefore, the prediction may include the number of expected response packets as well.

Each of the PSAs 520-1, 520-2, 520-3, and 520-4 may be implemented with its own corresponding hardware register or a virtual queue. A register-based PSA may use one register per port and store the sum of the expected sizes of the response packets handled thereby with respect to request packets currently being processed in the respective ports. This method may have the advantage of being simple to implement and being able to be updated in real time. Alternatively, a virtual queue-based PSA may operate in a method in which information of the request packets is sequentially stored and then the information is referenced and removed whenever the response packets arrive later (for example, the content of a queue may be referenced to determine expected traffic). The virtual queue may be useful in an environment where request packets may be processed simultaneously, and the correlation between the request packets and the response packets may be managed more precisely.

The PSAs 520-1, 520-2, 520-3, and 520-4 may be managed independently for each port, so the network device 500 may individually monitor and control the state of each port. The controller 530 may monitor values (e.g., sums of expected traffic) of the respective PSAs 520-1, 520-2, 520-3, and 520-4 in real time and may determine the possibility of traffic congestion based on this. For example, when a value of a PSA of a certain port (e.g., the port 510-1) exceeds a preset threshold value, the controller 530 may bypass the certain port by changing the data transmission path to flow through another corresponding port or may distribute traffic. The controller 530 may compare the traffic states between the ports 510-1, 510-2, 510-3, and 510-4 and dynamically control the state of a resource allocated to the network device 500.

Additionally, the ports 510-1, 510-2, 510-3, and 510-4 and the data transmission path may be closely related. The network device 500 determining to transmit data through a certain port may involve selecting a path that uses that certain port. For example, when it is determined to transmit and receive data through the port 510-1, a data path that uses the port 510-1 may be set. This may allow the network device 500 to select an appropriate path in real time based on the state of the port 510-1 during the path setting process.

The association between the PSAs 520-1, 520-2, 520-3, and 520-4 and the controller 530 may play an important role in predicting and alleviating traffic congestion in advance. For example, the controller 530 may pre-identify the traffic state that may occur in the future and respond appropriately by predicting the size of a response packet by analyzing the corresponding request packet. This may contribute to improving the efficiency of the data transmission path and optimizing the data throughput that the network device 500 may process.

FIG. 6 illustrates an example of components and an operating method of a switch, according to one or more embodiments.

Referring to FIG. 6, a switch 600 may include ports 610-1, 610-2, 610-3, and 610-4, respective PSAs 620-1, 620-2, 620-3, and 620-4, a switch core 640, and a controller 630.

The PSAs 620-1, 620-2, 620-3, and 620-4 may operate in the same manner as the role and implementation of the PSAs 520-1, 520-2, 520-3, and 520-4 described above with reference o FIG. 5. Accordingly, a detailed operation in which a value of a PSA is updated by adding the expected sizes of the response packets to the value of the PSA and by subtracting the corresponding sizes from the value of the PSA when the response packets arrive may be as described with reference to FIG. 5.

The switch core 640 may play a central role in relaying the flow of data in the switch 600 and setting a path. The switch core 640 may dynamically adjust a data path in association with the controller 630, and through this, the traffic states between certain ports may be compared and the data transmission path may be optimized if needed. For example, the controller 630 may determine the possibility of the occurrence of traffic congestion based on pieces of traffic information collected from the PSAs 620-1, 620-2, 620-3, and 620-4 and may change the data path passing through a certain port or may distribute traffic to other ports.

The components of the switch 600 are only examples, and the number of components and the coupling relationship may be variously changed depending on the implementation environment. For example, the switch 600 may include a greater number of ports and PSAs, and the interaction method between the switch core 640 and the controller 630 may also be adjusted depending on various network conditions.

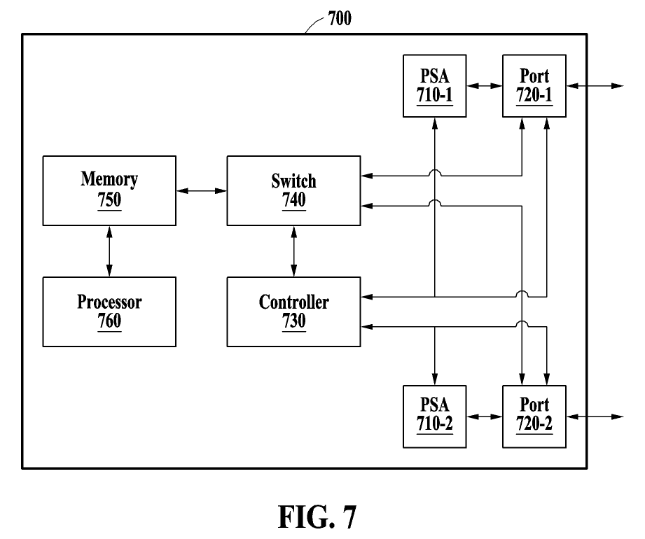

FIG. 7 illustrates an example of components and an operating method of a computing device, according to one or more embodiments.

Referring to FIG. 7, a computing device 700 may include ports 720-1 and 720-2, PSAs 710-1 and 710-2, a controller 730, a switch 740, a memory 750, and a processor 760.

The PSAs 710-1 and 710-2 may operate in the same manner as the role and implementation of the PSAs 520-1, 520-2, 520-3, and 520-4 described above with reference to FIG. 5.

The switch 740 may manage the flow of data in the computing device 700 and set a data path between an external network and internal components of the computing device 700. The switch 740 may adjust data traffic transmitted and received to and from the ports 720-1 and 720-2 in association with the controller 730 and dynamically change the data path if needed.

The controller 730 may monitor values of the PSAs 710-1 and 710-2 in real time, for example, and based on this, a traffic congestion state may be predicted and a data transmission path may be optimized. For example, when a value of a PSA of a certain port (e.g., the port 720-1) exceeds a threshold value, the controller 730 may change a data path passing through the certain port or may distribute traffic to the other port 720-2 by cooperating with the switch 740. This process may contribute to alleviating traffic congestion and increasing data transmission efficiency.

The memory 750 may store and search for data and may support large-capacity data processing in an HPC environment. The processor 760 may perform an operation task of processing a request packet or generating a response packet, which may be implemented as various types of processing devices such as a CPU, a GPU, or an NPU.

The components of the computing device 700 are only examples, and the number of components and the coupling relationship may be variously changed depending on the implementation environment. For example, the computing device 700 may include a greater number of ports and PSAs.

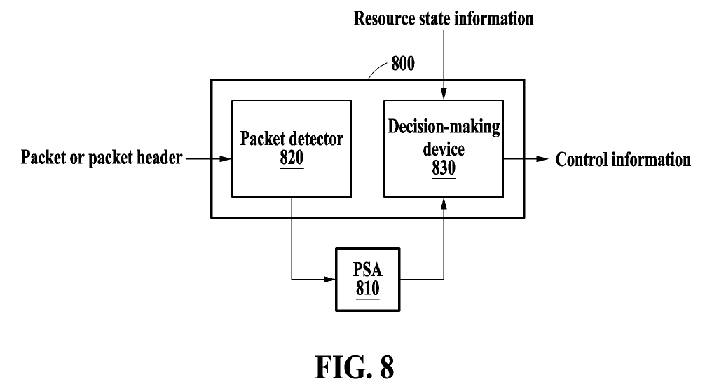

FIG. 8 illustrates an example of components and an operating method of a controller, according to one or more embodiments.

Referring to FIG. 8, a controller 800 (e.g., any of the controllers mentioned above) may include a packet detector 820 and a decision-making device 830. However, not all the illustrated components are essential. The controller 800 may be implemented with more or fewer components than the illustrated components. For example, although FIG. 8 illustrates that a PSA 810 exists separately from the controller 800, the PSA 810 may be included in the controller 800.

Referring to FIG. 8, an input packet or a packet header may first be processed in the packet detector 820. The packet detector 820 may distinguish whether a packet is a request packet or a response packet, analyze header information of the packet, and determine the size of a payload. The payload may refer to the size of actual data included in the packet, and for example, the request packet may include information related to the size of data to be returned as a response packet. The type and payload size of the identified packet may be transmitted to the PSA 810.

The PSA 810 may exist for each port (there may be a PSA for each respective port) and may store the expected/predicted sum of payloads of response packets that have not arrived yet through a corresponding port. The PSA 810 may be implemented as a hardware register or a virtual queue and may reflect a network traffic state by updating values in real time, for example. For example, when a request packet is received, the PSA 810 may add the expected size(s) of the response packets to the values, and when the response packets are received, the PSA 810 may subtract the sizes from the values, so the value of the PSA 810 may be maintained in an up-to-date state. The value of the PSA 810 may provide important information to reflect a traffic load in real time that is being processed in a certain link or port.

The value of the PSA 810 may be transmitted/provided to the decision-making device 830, and in addition, pieces of information, such as link bandwidth utilization, port queue depth, and port and/or link power states, may be collected and comprehensively analyzed by the decision-making device 830. Based on the pieces of information, the decision-making device 830 may change a data transmission path or dynamically adjust the setting of a certain link or port. For example, when the value of the PSA 810 exceeds a predetermined threshold value (e.g., the corresponding port is predicted to become saturated), the decision-making device 830 may decide not to transmit data through a corresponding channel but instead distribute the data/traffic to other channels. The decision may contribute to alleviating traffic congestion (e.g., on the saturated port/path) and maintaining the data processing efficiency of a network.

A routing decision may involve the decision-making device 830 dynamically setting or changing the transmission path of a data packet. A routing decision is intended to allow a packet to be transmitted through an optimal path and may be made by considering a network state and traffic load. In an environment where multiple data transmission paths exists between network devices, when the current resource usage of one path plus the amount of resource to be used by predicted future traffic exceed the amount of resource that is currently allocated, the decision-making device 830 may perform the routing decision to transmit traffic to other paths. For example, when there is a possibility of the occurrence of traffic congestion due to high bandwidth utilization of a certain link, the decision-making device 830 may change the path to route data to other links having low latency or low saturation.

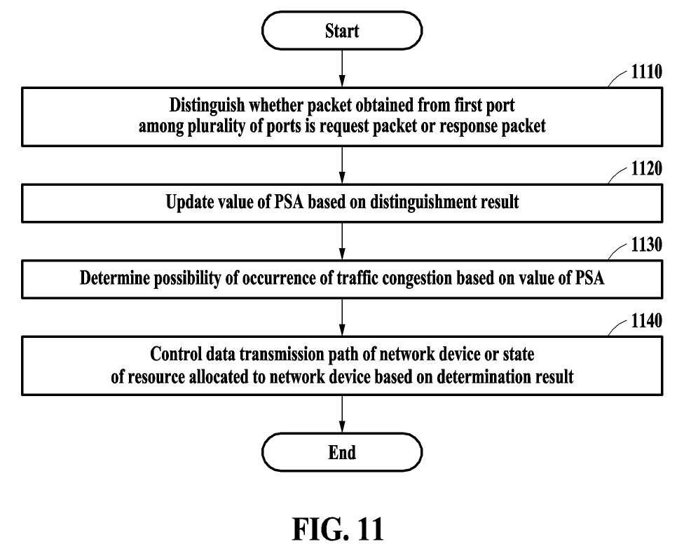

In addition, in an environment where multiple data transmission paths exists between network devices, in the case in which multiple paths are activated and used, when not much traffic is expected in the future, the decision-making device 830 may optimize the resource allocation by switching, among the currently activated paths, paths other than the required paths to a low power mode. Conversely, when additional traffic is expected beyond the currently allocated paths, the decision-making device 830 may optimize the resource allocation by preemptively activating paths. A detailed operating method of the decision-making device 830 is described with reference to FIGS. 11 to 14.

Regarding how the request packet indicates the size of the response data, the request packet header may include information about the payload size of the expected response. The PSA may accumulate the expected response size based on this header information, and as each response packet is received, the actual payload size may be subtracted from the PSA. For example, if the expected total response size is 1000 and each response carries a payload of 100, then 1000 is added to the PSA, and 100 is subtracted for each of the 10 response packets. A single request may result in multiple response packets, and the PSA may use the payload size of each received packet to decrement its internal value, thereby determining when the full response has been received.

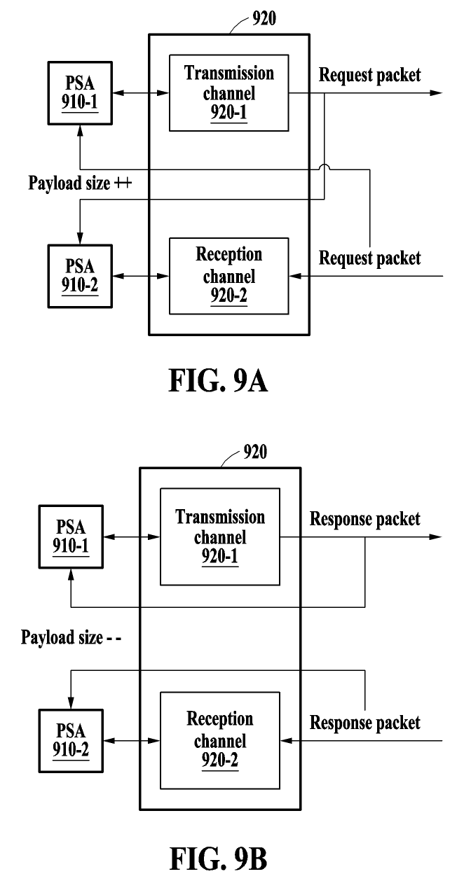

FIGS. 9A and 9B illustrate examples of a structure in which an independent PSA exists in each of a transmission channel and a reception channel of a port, according to one or more embodiments.

An update of the value of a PSA may be performed based on the interaction between each channel, according to a request packet and a response packet. In the case of a request packet, the value of the PSA may increase in the counterpart channel, which may be used to predict a traffic load in which the response packet arrives in the future. Conversely, in the case of the response packet, the value of the PSA of a corresponding channel may decrease, which may be considered as a process of eliminating previously stored request packet-related data. That is, the PSA may be managed independently for each channel of a port, and through this, a controller may analyze the network traffic state in more detail and make an efficient routing decision.

More specifically, referring to FIG. 9A, when a request packet is transmitted through a transmission channel 920-1 of a port 920, a PSA 910-2 may increase the value of a PSA of a counterpart channel (e.g., a reception channel 920-2). This may be performed by adding the payload size that is identified in a header of the request packet to the value of the PSA of the counterpart/reception channel. This update may reflect an expected traffic load of the response packet that will occur when the response packet arrives after the request packet is transmitted. Similarly, when a request packet is received through the reception channel 920-2, the expected traffic load of the counterpart channel may be reflected by adding the payload size of the request packet to the value of the PSA of the transmission channel 920-1. This mechanism may manage the value of the PSA based on the interaction between channels and may contribute to more accurate tracking of the overall traffic state.

Referring to FIG. 9B, when a response packet is processed, the value of a PSA may decrease in the opposite direction from the corresponding request packet. For example, when the response packet is transmitted through the transmission channel 920-1, a PSA 910-1 may subtract the payload size of the response packet from the value of the PSA 910-1. This may reflect the arrival of the response packet with respect to the request packet processed in a corresponding channel. Similarly, when the response packet is received through the reception channel 920-2, the PSA 910-2 may update according to the payload size of the response packet, specifically, by subtracting the payload size of the response packet from the value of the PSA 910-2. This subtraction operation may play an important role in adjusting the traffic state of a corresponding channel in real time, for example (or with high responsiveness), and maintaining the traffic state relatively up-to-date.

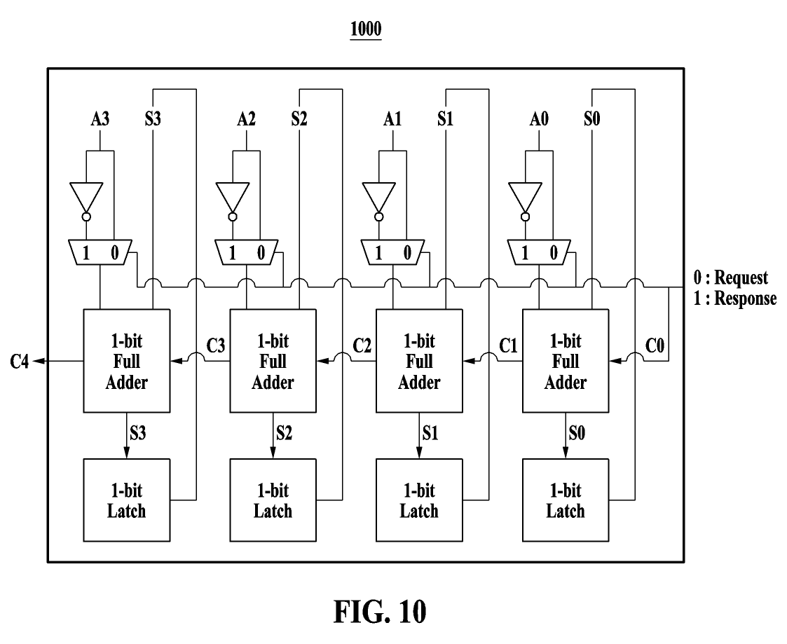

FIG. 10 illustrates an example of a hardware configuration of a PSA and illustrates an operation of addition and subtraction of a value of the PSA based on a 4-bit structure, according to one or more embodiments.

A PSA may accumulate and calculate or reduce the payload sizes of request packets and response packets, thereby managing a traffic state of each channel.

Referring to FIG. 10, a PSA 1000 may include four 1-bit full adders and four 1-bit latches corresponding to each bit. When values of the PSA 1000 are added to the payload size, the payload size of the request packet may be transmitted to the PSA 1000 through inputs A0 to A3. The input bits of the request packet may be added to the existing value of the PSA 1000 through the full adder, and each operation result may be stored in the corresponding 1-bit latch. For example, when the A0 bit is 1 and the S0 bit of the existing PSA is 1, the full adder may add A0 and S0 and obtain 2, which may be transmitted to the upper bit through a C1 carry bit. The upper bits, A1 and S1, may perform an operation by including the value of C1, and a new value of the PSA 1000 may be calculated.

In contrast, when the value of the PSA 1000 decreases according to a response packet, the payload size of the response packet may be transmitted through the inputs A0 to A3. In this case, the full adder may perform an operation of subtracting the bits of the response packet from the existing value of the PSA 1000. The subtraction operation may be performed using the 2's complement of the input bit value, and the full adder may implement the subtraction by adding this value to the existing value of the PSA 1000. For example, when the A0 bit is 1 and the S0 bit of the existing PSA is 1, the value obtained by adding the 2's complement of A0 may be calculated by the full adder, so a new value of the PSA 1000 including a C1 bit may be generated.

The 1-bit latch may store the operation result of the full adder and maintain the state of the PSA 1000 even after the operation of each bit is completed. This may allow the PSA 1000 to store independent values for each bit, ensuring that the value of the PSA 1000 may be used in a subsequent operation.

The hardware structure of the PSA 1000 illustrated in FIG. 10 is only an example; other configurations may be used. The PSA 1000 may be implemented based on a variety of hardware and software depending on certain network environments or design requirements. For example, in addition to the structure that uses the 1-bit full adder and the 1-bit latch shown in the diagram, the PSA 1000 may also be implemented through a more complex operation device or programmable hardware such as an FPGA and an application-specific integrated circuit (ASIC). Additionally, the PSA 1000 may be implemented virtually based on a memory and a processor using a software algorithm, and this design may be adjusted in various ways depending on system performance, power consumption, and cost constraints.

FIG. 11 illustrates an example of an operating method of a network device, according to one or more embodiments.

For ease of description, operations 1110 to 1140 are described as being performed using the network device 500 illustrated in FIG. 5. However, operations 1110 to 1140 may be performed by another suitable electronic device in a suitable system.

In operation 1110, the network device 500 may distinguish whether a packet obtained from a first port among a set of ports is a request packet or a response packet.

In operation 1120, the network device 500 may update a value of a PSA based on the distinguishment result. When the obtained packet is a request packet, the network device 500 may obtain the payload size of the corresponding expected response packet (which is to be received as a response to the request packet) from a header of the request packet.

The network device 500 may increase the value of the PSA based on the payload size of the expected response packet (to be received as a response to the request packet) when the obtained packet is a request packet.

The network device 500 may decrease the value of the PSA based on the payload size of the obtained packet when the obtained packet is a response packet.

In operation 1130, the network device 500 may determine the possibility of the occurrence of traffic congestion based on the value of the PSA (e.g., by comparing the value of the PSA to a threshold, which may be static or which may dynamically vary according to various conditions). The network device 500 may obtain a state of a resource allocated to the network device 500 and determine the possibility of the occurrence of the traffic congestion based on the value of the PSA and the state of the resource allocated to the network device 500.

The resource allocated to the network device 500 may be a physical or logical resource used in the process in which the network device 500 processes the packet and transmits and receives data. The resource may include internal or external components of the network device 500, and the state and utilization of the resource may change dynamically depending on a network traffic state.

For example, the resource allocated to the network device 500 may include a channel connected to each port, a bandwidth, a packet queue, a power state, a memory, and an operation ability. Each port may transmit and receive data to and from transmission and reception channels, and the bandwidth of each channel may act as a physical resource that limits the amount of data that may be transmitted along a certain path. The packet queue may be a logical resource that temporarily stores a packet entering or exiting through a port and supports efficient traffic management when the packet is processed or in a transmission standby state.

In addition, the power state may be one of the important aspects of the resource, and the availability of the resource may be determined based on whether the port or channel of the network device 500 is in an active state or a low power state. For example, a port with low traffic may be switched to a low-power state to reduce power consumption. The memory may also be a major resource allocated to the network device 500, and the PSA may be used to store the size of the packet or the expected size of response traffic.

In operation 1140, based on the determination result, the network device 500 may control a data transmission path of the network device 500 or the state of the resource allocated to the network device 500.

The network device 500 may determine that the traffic congestion occurs in the data transmission path through the first port when the value of the PSA satisfies a preset first condition. The network device 500 may limit the transmission of the request packet to the data transmission path through the first port based on the determination result that the traffic congestion occurs. In addition, based on the determination result that the traffic congestion occurs, the network device 500 may secure an additional path by changing, among the ports, a power state of a port of which the power state satisfies the preset first condition.

The network device 500 may determine that the traffic congestion does not occur in the data transmission path through the first port when the value of the PSA satisfies a preset second condition. Based on the determination result that the traffic congestion does not occur, the network device 500 may retrieve the resource allocated to the network device 500 by changing, among the set of ports, a power state of a port of which the power state satisfies the preset second condition.

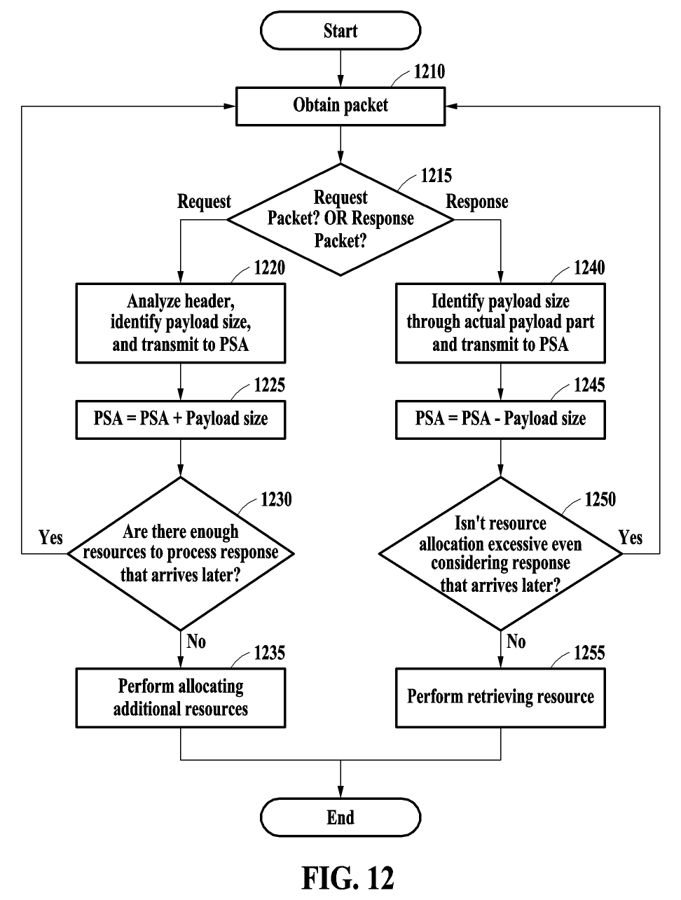

FIG. 12 illustrates an example of an operating method of a network device, according to one or more embodiments.

For ease of description, operations 1210 to 1255 are described as being performed using the network device 500 illustrated in FIG. 5. However, operations 1210 to 1255 may also be performed by another suitable electronic device in a suitable system.

In operation 1210, the network device 500 may obtain a packet through a port. In operation 1215, the network device 500 may determine whether the obtained packet is a request packet or a response packet, for example, by analyzing a header of the obtained packet (or data of the packet) and determine whether the packet is a request packet or a response packet.

In operation 1220, the network device 500 may analyze the header and identify the payload size of the obtained packet to determined that the obtained packet is a request packet. In operation 1225, the payload size may be accumulated into (added to) the value of a PSA. For example, when the request packet has a payload size of 100, the PSA may be updated by adding 100 to the existing value. In operation 1230, the traffic load of the response packet that will additionally arrive may be predicted based on the value of the PSA, and the prediction result may be used to evaluate the sufficiency of a resource. In operation 1235, an operation of allocating an additional resource may be performed when it is determined that the resource is insufficient.

In contrast, in operation 1240, when the obtained packet is determined to be a response packet, the payload size of the obtained/response packet may be identified. In operation 1245, the PSA may be updated by subtracting the identified payload size from the existing value of the PSA. For example, when the payload size of the response packet is 50, the PSA may be updated by subtracting 50 from the existing value of the PSA. In operation 1250, a current state of the resource may be evaluated, and it may be determined whether the resource is available considering the arrival of the response packet (i.e., whether there is excess resource). In operation 1255, an operation of retrieving/deallocating the resource may be performed when it is determined that the resource is available. For example, a method of reducing energy consumption by converting an unnecessary path into a low-power state may be used.

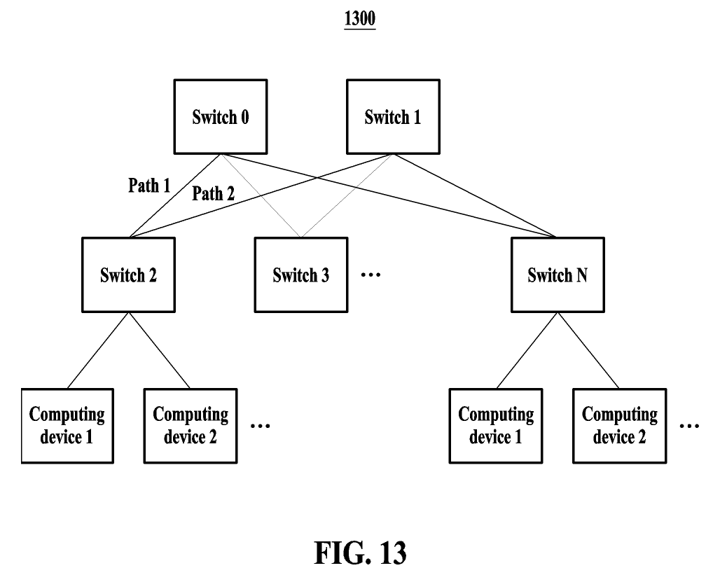

FIG. 13 illustrates an example of a process of determining routing in a switch, according to one or more embodiments.

Referring to FIG. 13, there may be two options for a path through which data is transmitted from switch 2 to switch N: through switch 0 or switch 1. Path 1 passes through the switch 0, and many request packets may already be transmitted through the path 1. The switch 2 may use a PSA and predict the amount of corresponding response packets that will be returned through the path 1. For example, even when the current resource utilization is only 70%, when the value of the PSA is high, it may be determined that an additional request packet is not to be transmitted along the corresponding path (path 1) by considering the possibility of the occurrence of future traffic congestion.

Instead, the switch 2 may select the other path having a relatively lower value of the PSA and transmit the packet. For example, path 2 passing through the switch 1 may be determined to be currently in a state in which fewer request packets are transmitted and may therefore be determined to be unlikely to have traffic congestion in the future. In this case, the switch 2 may select a path of the switch 1 based on data of the PSA and transmit the request packet, thereby preventing traffic congestion in a path of the switch 0 in advance. The changing of paths by switch 0 may be implemented by using a port of switch 0 that corresponds to the alternate path (e.g., a port of switch 2 that is connected to switch 0 in path 2).

Such a routing decision may be made based on future traffic information predicted through the PSA. The PSA may track the sizes of the request and response packets for each channel in real time and be used to predict the future traffic state in a certain path. This information may be used to dynamically adjust the routing decision and the state of the network resource in association with a controller.

Accordingly, the routing optimization method may maximize the network performance and enable an efficient use of the resource by predicting future traffic congestion in advance, in addition to the current traffic state, and determining a path based on this.

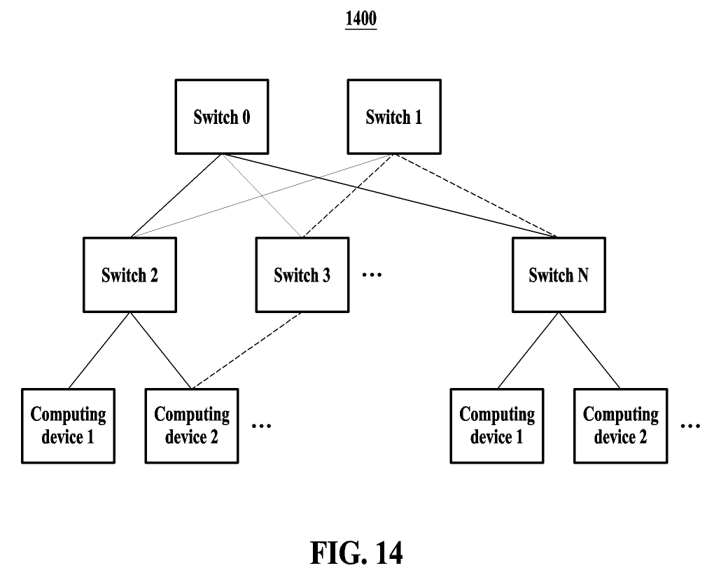

FIG. 14 illustrates an example of a process in which a network device dynamically changes a power state to achieve resource utilization and power optimization, according to one or more embodiments.

Referring to FIG. 14, in an initial state, switch 3 may be in a low-power state. This may be because there is not much traffic at the moment, so there may be no need to activate the switch 3. A path for data to be transmitted from computing device 2 to switch N may be used through the switch 2, and only 70% of the current resource may be used. However, a high value of a PSA may indicate that many response packets are expected to arrive in the path. In this situation, the current resource may not be sufficient to process the future traffic load.

The computing device 2 may predict the future traffic load through the PSA and transmit a signal to the switch 3 (if needed) so that the switch 3 may be converted from a low-power state into an active state. Accordingly, the switch 3 may be prepared to process additional traffic, and data transmission from the computing device 2 to the switch N may be performed without a delay. In this way, utilization of the network resource may be maximized and power consumption may be minimized by predicting the future traffic state in advance and responding to the predicted future traffic state appropriately.

In FIG. 14, the computing device 2 may evaluate a state of the switch 3 based on the value of the PSA and adjust the power state of the switch 3 if needed. In this process, the PSA may track the sizes of the request and response packets in real time, which are being processed in each path, and through this, the traffic state that occurs in the future may be predicted. For example, when the value of the PSA of the computing device 2 exceeds a threshold value, the computing device 2 may switch the path to the switch 3 or activate an additional resource.

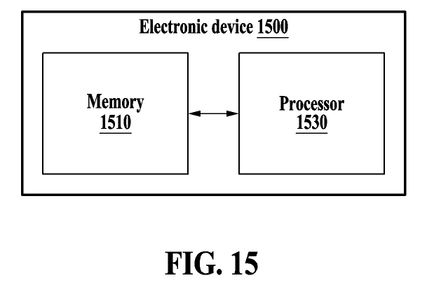

FIG. 15 illustrates an example of an electronic device, according to one or more embodiments.

Referring to FIG. 15, an electronic device 1500 may include a memory 1510 and a processor 1530. The electronic device 1500 may include various computing devices, such as an HPC, a mobile phone, a smartphone, a tablet, a camera device, an e-book device, a laptop, a personal computer (PC), a desktop, a workstation, or a server, various wearable devices, such as a smart watch, smart glasses, a head-mounted display (HMD), or smart clothing, various home appliances, such as a smart television (TV) or a smart refrigerator, and other devices, such as a smart vehicle, a smart kiosk, an Internet of Things (IoT) device, a walking assist device (WAD), a drone, or a robot.

The memory 1510 may store instructions (e.g., programs) executable by the processor 1530. For example, the instructions may include instructions for executing the operation of the processor 1530 and/or the operation of each component of the processor 1530.

The memory 1510 may be implemented as a volatile memory device or a non-volatile memory device.

The volatile memory device may be implemented as dynamic random-access memory (DRAM), static RAM (SRAM), thyristor RAM (T-RAM), zero capacitor RAM (Z-RAM), or twin transistor RAM (TTRAM).

The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate memory (NFGM), holographic memory, a molecular electronic memory device, or insulator resistance change memory.

The processor 1530 may process data stored in the memory 1510. The processor 1530 may execute computer-readable code (e.g., software) stored in the memory 1510 and instructions triggered by the processor 1530.

The processor 1530 may be a hardware-implemented data processing device having a circuit that is physically structured to execute desired operations. The desired operations may include, for example, code or instructions included in a program.

The hardware-implemented data-processing device may include, for example, a microprocessor, a CPU, a processor core, a multi-core processor, a multiprocessor, an ASIC, an FPGA, or combinations thereof.

The processor 1530 may determine the possibility of the occurrence of traffic congestion based on a value of a PSA and may control a data transmission path of a network device or a state of a resource allocated to the network device based on the determination result. The processor 1530 may perform the operations described with reference to FIGS. 1 to 14 in substantially the same manner. Accordingly, a further description thereof is omitted herein.

A network device may include computing devices and switches grouped into groups, in which the switches in the same group may be fully connected to the computing devices in the corresponding group, and each of the switches included in a first group among the groups may be connected to only one of the switches included in a second group. At least one of the switches included in the first group may include a PSA configured to add, when a first message is transmitted, the length/size of a second message to be received as a response to the first message and configured to subtract the length/size of the second message when the second message is received and a controller configured to determine the possibility of the occurrence of traffic congestion based on a value calculated by the PSA and configured to control the transmission of a message to another one of the switches included in the second group through another physical port when it is determined that there is the possibility of the occurrence of the congestion according to the determination result.

A network management device may include computing devices and switches grouped into groups, in which the switches in the same group may be fully connected to the computing devices in the corresponding group, and each of the switches included in a first group among the groups may be connected to only one of the switches included in a second group. At least one of the computing devices included in the first group may include a PSA configured to add, when a first message is transmitted, the length of a second message to be received as a response to the first message and configured to subtract the length of the second message when the second message is received and a controller configured to determine the possibility of the occurrence of traffic congestion based on a value calculated by the PSA and configured to control the transmission of a message to another one of the switches included in the first group through another physical port when it is determined that there is the possibility of the occurrence of the congestion according to the determination result. The message may refer to a packet.

In a network device including computing devices and switches grouped into groups, at least one of the switches included in a first group may include a PSA configured to add, when a first message is transmitted, the length/size of a second message to be received as a response to the first message and configured to subtract the length/size of the second message when the second message is received and a controller configured to determine the possibility of the occurrence of traffic congestion based on a value calculated by the PSA and configured to control the transmission of a message to another one of the switches included in a second group based on the determination result.

In a network device including computing devices and switches grouped into groups, at least one of the computing devices included in a first group may include a PSA configured to add, when a first message is transmitted, the length of a second message to be received as a response to the first message and configured to subtract the length of the second message when the second message is received and a controller configured to determine the possibility of the occurrence of traffic congestion based on a value calculated by the PSA and configured to control the transmission of a message to another one the switches included in the first group based on the determination result.

In a network device including computing devices and switches grouped into groups, at least one of the computing devices included in a first group among the groups may include a first PSA configured to add, when a first message is transmitted, the length of a second message to be received as a response to the first message and configured to subtract the length of the second message when the second message is received and a first scheduler (or a controller) configured to determine the possibility of the occurrence of traffic congestion based on a value calculated by the first PSA and configured to control the transmission of a message to another one of the switches included in the first group according to the determination result. At least one of the switches included in the first group may include a second PSA configured to add, when a third message is transmitted, the length of a fourth message to be received as a response to the third message and configured to subtract the length of the fourth message when the fourth message is received and a second controller configured to determine the possibility of the occurrence of traffic congestion based on a value calculated by the second PSA and configured to control the transmission of a message to another one of the switches included in a second group according to the determination result.

In a network device including computing devices and switches, at least one of the computing devices may include a PSA configured to add, when a first message is transmitted, the length of a second message to be received as a response to the first message and configured to subtract the length of the second message when the second message is received and a controller configured to determine the possibility of the occurrence of traffic congestion based on a value calculated by the PSA and configured to control the transmission of a message to another one of the switches based on the determination result.

The computing apparatuses, the electronic devices, the processors, the memories, the information output system and hardware, the storage devices, and other apparatuses, devices, units, modules, and components described herein with respect to FIGS. 1-15 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term "processor" or "computer" may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-15 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An operating method of a network device comprising ports, the operating method comprising:
determining whether a packet obtained from a first port among the ports is a request packet or a response packet;
updating a value of a payload size accumulator (PSA) based on a result of the determining; and
based on the value of the PSA, controlling a data transmission path of the network device or a state of a resource allocated to the network device.

2. The operating method of claim 1, wherein the obtained packet is a request packet, and wherein the updating of the value of the PSA comprises obtaining a payload size of a response packet to be received as a response to the request packet, the payload size obtained from a header of the request packet based on the obtained packet being a request packet.

3. The operating method of claim 1, wherein the obtained packet is a request packet, and wherein the updating of the value of the PSA comprises increasing the value of the PSA based on a payload size of a response packet to be received as a response to the request packet , the payload size obtained based on the obtained packet being a request packet.

4. The operating method of claim 1, wherein the obtained packet is a response packet, and wherein the updating of the value of the PSA comprises decreasing the value of the PSA based on a payload size of the response packet, the payload size based on the obtained packet being a response packet.

5. The operating method of claim 1, wherein the obtained packet is a request packet,
wherein the controlling the data transmission path based on the value of the PSA comprises:
determining that the value of the PSA satisfies a preset first condition, and
based thereon limiting transmission of the request packet to the data transmission path through the first port.

6. The operating method of claim 1, further comprising:
determining that traffic congestion occurs in the data transmission path through the first port in response to the value of the PSA satisfying a preset first condition, and based thereon, securing an additional path by changing, among the ports, a power state of a port.

7. The operating method of claim 1, wherein based on the value of the PSA satisfying a preset second condition,
freeing or reclaiming the resource allocated to the network device.

8. The operating method of claim 1, further comprising:
obtaining the state of the resource allocated to the network device; and
wherein the controlling the data transmission path or the state of the resource is also based on the obtained state of the resource allocated to the network device.

9. The operating method of claim 1, wherein the obtained packet is a response packet, which is received as a response to a request packet transmitted through the data transmission path through the first port, and wherein the obtained response packet is received by the first port through the same data transmission path.

10. The operating method of claim 1, wherein the network device comprises a computing device or a switch.

11. A non-transitory computer-readable storage medium storing instructions that, when executed by a processor, cause the processor to perform the operating method of claim 1.

12. A network device comprising:
ports;
a controller configured to determine whether a packet obtained from a first port among the ports is a request packet or a response packet;
a payload size accumulator (PSA) comprising a register or queue, configured to add-to or subtract-from, a value maintained in the register or queue, a payload size based on a result of the determining; and
wherein the controller is further configured to:
based on the value, control a data transmission path of the network device or a state of a resource allocated to the network device.

13. The network device of claim 12, wherein the obtained packet is a request packet, wherein the payload size is a payload size of a response packet to be received as a response to the request packet, and wherein the payload size of the response packet is obtained from a header of the request packet.

14. The network device of claim 12, wherein the obtained packet is a request packet, and based thereon the PSA adds, to the value, a payload size of a response packet that is to be received as a response to the request packet.

15. The network device of claim 12, wherein the obtained packet is a response packet, and wherein the PSA is configured to subtract a payload size of the obtained response packet based on the obtained packet being a response packet.

16. The network device of claim 12, wherein the controller is configured to:
select the first port based on the value of the PSA satisfying a preset first condition, and, based thereon, limit transmission of the obtained packet to the data transmission path through the first port based.

17. The network device of claim 12, wherein the controller is configured to:
select the first port based on the value of the PSA satisfying a preset first condition, and, based thereon, secure an additional path by changing, among the ports, a power state of a port of which the power state corresponds to satisfaction of the preset first condition.

18. The network device of claim 12, wherein the controller is configured to:
based on the value of the PSA satisfying a preset second condition, free or reclaim the resource allocated to the network device.

19. The network device of claim 12, wherein the controller is configured to:
obtain the state of the resource allocated to the network device; and
control the data transmission path or the state of the resource based on the value of the PSA and based on the state of the resource allocated to the network device.

20. The network device of claim 12, wherein the obtained packet is a response packet which is received as a response to a corresponding request packet transmitted through the data transmission path through the first port, and wherein the response packet is received by the first port through the same data transmission path.
